(19) United States
(12) Patent Application Publication
(10) Pub. No.: US 2010/0112441 A1
(43) Pub. Date: May 6, 2010

(54) BINDER FOR SECONDARY BATTERY ELECTRODE, SECONDARY BATTERY ELECTRODE, AND SECONDARY BATTERY

(76) Inventors: Mayumi Fukumine, Kanagawa-ken (JP); Yasuhiro Wakizaka, Kanagawa-ken (JP)

Correspondence Address: BIRCH STEWART KOLASCH & BIRCH, PO BOX 747, FALLS CHURCH, VA, 22040-0747, US

(21) Appl. No.: 12/594,133

(22) PCT Filed: Mar. 31, 2008
(86) PCT No.: PCT/JP2008/056422

§ 371 Date: Sep. 30, 2009

(30) Foreign Application Priority Data
Mar. 30, 2007 (JP) 2007-090742

(51) Int. Cl. H01M 4/62

(52) U.S. Cl. 429/217

(57) ABSTRACT

The present invention aims at improving binding continuity, rate property, cycle property and short circuit ratio by lowering a inner resistance of electrode in a secondary battery.

A binder for secondary battery electrode according to the present invention is comprised a polymer having weight-average molecular weight of 5000 to 2500000 formed by polymerizing a monomer composition including fluorine atom containing monomer represented by following formula (I).

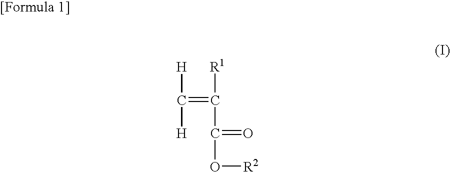

(R¹ is hydrogen or methyl group, R² is hydrocarbon group having carbon number 6 to 18 containing fluorine atom).

### TECHNICAL FIELD

The present invention relates to a binder for secondary battery such as a lithium ion secondary battery and a nickel hydrogen secondary battery, a binder composition for secondary battery electrode, a slurry for secondary battery electrode, an electrode for secondary battery and a secondary battery using thereof.

### BACKGROUND ART

An electrode for battery is produced normally by dissolving a binder for electrode (herein after merely referred as “binder”) in a solvent and dispersing into a dispersion medium to form a binder composition, and applying a slurry for electrode (herein after merely referred as “slurry”) wherein an active material is mixed to the binder composition to a collector, removing the solvent or dispersion medium by a method such as drying, etc. so that binding between the active material and the collector and between each of the active materials.

In addition to a type and amount of the active material, a type and amount of an electrolytic solution, a binder becomes essential deciding factor for characteristic matters such as a capacity of battery, cycling property, rate property. If the binder cannot bind sufficient amount of the active material to the collector, and cannot bind the active materials each other, a battery having large capacity cannot be obtained. Also, if a binding force of the binder is decreased by volume variation of the active material by repeating discharge and charge, a capacity of battery is decreased due to loss of the active material from the collector. Therefore, various suggestion has been made to the binder (Patent Document 1, Patent Document 2).

In the meantime, with respect to the binder, conventionally, there was knowledge that the battery capacity, the cycle property and the rate property are decreased, because a battery reaction is prevented, if the active material is coated by the binder to deeply cover a surface.

Therefore, it has been required to the binder that a strength binding property between the active material and the collector and between each of the active materials, long-lasting binding property so as not to cause loosing the active material from the collector even by repeating discharge and charge, as well as to expose a surface of the active material by coating as lines and points not by coating its surface.

As for the binder in this manner, a binder comprised a polymer having a repeating unit derived from fluorinated alkyl (meth)acrylate is suggested in Patent Document 3. In Patent Document 3, as for the fluorinated alkyl (meth)acrylate, emulsion polymerization is conducted by using trifluoroethyl (meth)acrylate in which a carbon number of alkyl portion is 2 and obtaining a latex, the latex is used as a binder. In a battery electrode obtained by using the active material and the latex, because a polymer exists as granular form, a deep cover property to the active material is low, it is considered that the electrode is formed along the above conventional knowledge.

### Patent Document 1: Japanese Patent Laid Open No. 5-21068

### Patent Document 2: Japanese Patent Laid Open No. 5-74461

### Patent Document 3: Japanese Patent Laid Open No. 2002-42819

### DISCLOSURE OF INVENTION

### Problem to be Solved by the Invention

Under the above circumstance, the inventors of the present invention keen examined for providing a binder for secondary battery electrode which is obtainable a secondary battery having large battery capacity and a long-lasing binding property even repeating discharge and charge, they obtained a knowledge that an interface resistance between the active material and the binder is reduced considerably by using a specific polymer as a binder.

When the interface resistance is lowered, a heat generation at a time of discharge and charge is decreased because an internal resistance of the electrode is lowered. As a result, it is expected that a volume variation of the active material at the time of discharge and charge effective to the long-lasting binding property can be reduced. Also, a high speed discharge and charge property improvement is expected because the internal resistance is decreased.

### Means for Solving the Problem

As a result of intentional study by the present inventors for developing a new binder for secondary battery electrode, in case of using a polymer having weight-average molecular weight of 5000 to 2500000 formed by polymerizing a monomer composition having acrylic acid ester or methacrylic acid ester which includes hydrocarbon group of carbon number 6 to 18 containing fluorine atom, an interface resistance between the active material and the binder is lowered, thereby a secondary battery wherein a rate property, a cycle property, a short circuit ratio are improved can be obtained, and the present inventors have reached to complete of the present invention.

Namely, the present invention which solves the above problem comprise following matters as gist.

(1) A binder for secondary battery electrode comprising a polymer having weight-average molecular weight of 5000 to 2500000 formed by polymerizing a monomer composition including fluorine atom containing monomer represented by following formula (I).

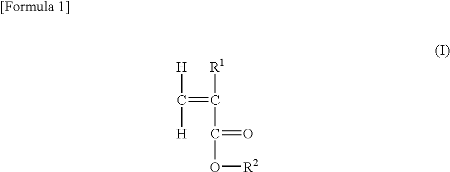

(R¹ is hydrogen or methyl group, R² is hydrocarbon group having carbon number 6 to 18 containing fluorine atom).

(2) The binder for secondary battery electrode as set forth in (1) wherein a ratio of repeating unit derived from monomer represented by said formula (I) included in said polymer is 1 to 100 wt %.

(3) The binder for secondary battery electrode as set forth in (1) or (2), wherein said monomer composition further comprises ethylenic unsaturated carboxylic acid ester monomer.

(4) A binder composition comprising an organic solvent and dissolved therein the binder for secondary battery electrode binder as set forth in any one of said (1) to (3) in an organic solvent.

(5) A slurry for secondary battery electrode comprising the binder composition as set forth (4), and a positive electrode active material or a negative electrode active material.

(6) A secondary battery electrode, wherein an active material layer comprising the binder for secondary battery electrode as set forth in any one of said (1) to (3), and a positive electrode active material or a negative electrode active material is adhered to a collector.

(7) A secondary battery comprising the secondary battery electrode as set forth in said (6).

### EFFECTS OF THE INVENTION

When a binder of the present invention is used, an interface resistance between an active material and a binder is decreased, as a result, an internal resistance of the electrode is lowered. Therefore, a long-lasting binding property is improved, because heat generation at a time of discharge and charge is lowered. Also, an internal resistance of the electrode is lowered, a rate property, a cycle property and a short circuit ratio are improved.

### BEST MODE FOR WORKING THE INVENTION

Herein after, the present invention will be specified, precisely.

1. Binder

A binder for secondary battery electrode of the present invention is comprised a polymer having a monomer composition including fluorine atom containing monomer represented by following formula (I).

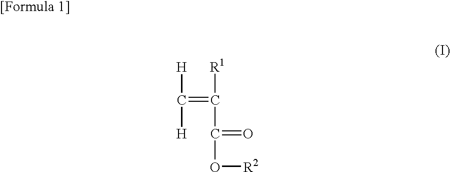

In the formula (I), R¹ is hydrogen or methyl group, R² is hydrocarbon group having carbon number 6 to 18, preferably 7 to 16, further preferably 8 to 12 containing fluorine atom. When the carbon number having fluorine atom exists within the above range, a secondary battery having advantageous of the rate property, the cycle property and a short circuit ratio can be obtained.

R² is preferably fluoroalkyl group or fluorocycloalkyl group, fluoroalkyl group is further preferably, primary fluoroalkyl group is particularly preferably in view of improving a dispersibility of a slurry and the rate property. Also, a content ratio of the fluorine atom in R² is as a substituting ratio of hydrogen atom, ⅓ or more is preferable, ½ or more is further preferable and ⅔ is particularly preferable.

As a further specific example of hydrocarbon group having fluorine atom (R²) is that:

CₙF₂ₙ₊₁C₂X₄— (n is 4 to 16, preferably 5 to 15 of integer, X is exemplified as 2-(perfluoroalkyl)ethyl group shown by hydrogen or fluorine. As for the 2-(perfluoroalkyl)ethyl group,

2-(perfluorobutyl)ethyl group, 2-(perfluoropentyl)ethyl group, 2-(perfluorohexyl)ethyl group, 2-(perfluoroheptyl)ethyl group, 2-(perfluorooctyl)ethyl group, 2-(perfluorononyl)ethyl group, 2-(perfluorodecyl)ethyl group, 2-(perfluorododecyl)ethyl group, 2-(perfluorotetradecyl)ethyl group, 2-(perfluorohexadecyl)ethyl group, etc. are exemplified.

Therefore, as for a preferable monomer unit having constitution represented by the formula (I), 2-(perfluoroalkyl)ethyl acrylate such as 2-(perfluorobutyl)ethyl acrylate, 2-(perfluoropentyl)ethyl acrylate, 2-(perfluorohexyl)ethyl acrylate, 2-(perfluorooctyl)ethyl acrylate, 2-(perfluorononyl)ethyl acrylate, 2-(perfluorodecyl)ethyl acrylate, 2-(perfluorododecyl)ethyl acrylate, 2-(perfluorotetradecyl)ethyl acrylate, 2-(perfluorohexadecyl)ethyl acrylate, and 2-(perfluoroalkyl)ethyl methacrylate such as 2-(perfluorobutyl)ethyl methacrylate, 2-(perfluoropentyl)ethyl methacrylate, 2-(perfluorohexyl)ethyl methacrylate, 2-(perfluorooctyl)ethyl methacrylate, 2-(perfluorononyl)ethyl methacrylate, 2-(perfluorodecyl)ethyl methacrylate, 2-(perfluorododecyl)ethyl methacrylate, 2-(perfluorotetradecyl)ethyl methacrylate, 2-(perfluorohexadecyl)ethyl acrylate, etc. are exemplified.

The binder of the present invention may be a polymer of fluorine-containing monomer represented by the above mentioned generic formula (I), or may be a copolymer with a co-monomer which is available to copolymerize with said fluorine-containing monomer. As for such the co-monomer, ethylenic unsaturated carboxylic acid ester monomer, acid group containing ethylenic unsaturatedmonomer, other ethylenic unsaturated monomer, diene monomer, etc. are exemplified. In case that said co-monomer, it is preferably 0 to 99 wt %, more preferably 25 to 98 wt %, particularly preferably 50 to 95 wt %.

As examples for the ethylenic unsaturated carboxylic acid ester monomer, acrylic acid ester such as, methyl acrylate, ethyl acrylate, propyl acrylate, butyl acrylate, 2-ethylhexyl acrylate, 2-hydroxypropyl acrylate, dimethylaminoethyl acrylate; methacrylic acid ester such as methyl methacrylate, ethyl methacrylate, propyl methacrylate, butyl methacrylate, 2-ethylhexyl methacrylate, 2-hydroxypropyl methacrylate, dimethylaminoethyl methacrylate; wholly esterified unsaturated multivalent carboxylic acid such as diethyl maleate, dibutyl maleate, dioctyl itaconate are exemplified. In these, 1 to 12 carbon number of alkyl portion of acrylic acid ester and methacrylic acid ester are exemplified as a preferable example, in view of improving electrode properties such as flexibility and binding property.

For the acid group containing ethylenic unsaturatedmonomer, it is not particularly limited if ethylenic unsaturated monomer including acid group such as carboxyl group, sulphonic acid group, phosphoric group, etc. As for specific examples, in carboxylic containing ethylenic unsaturated monomer, unsaturated monocarboxyic acid such as acrylic acid, methacrylic acid, crotonic acid; ethylenic unsaturated dicarboxylic acid such as maleic acid, fumaric acid, etc; partially esterified ethylenic unsaturated multivalent carbonic acid such as monomethyl maleate, monoethyl itaconate are exemplified.

As for sulphonic group containing ethylenic unsaturated monomer, ethylenic unsaturated sulphonic acid such as vinyl sulphonic acid, styrenesulfonic acid, allylsulfonic acid, methallylsulfonic acid; 2-acrylamide-2-methylpropanesulfonic acid, 3-sulfopropaneacrylic acid ester, 3-propanemethacrylic acid ester, sulfobis-(3-sulfopropyl)itaconic acid ester, etc. are exemplified.

As for phosphoric group containing ethylenic unsaturated monomer, vinyl phosphonic acid, vinyl phosphate, bis(methacryloxyethyl)phosphate, diphenyl-2-methacryloxyethyl phosphate3-allyloxy-2-hydroxypropanoic phosphate, etc. are exemplified. In these, unsaturated monocarbonic such as acrylic acid ester, methacrylic acid ester and unsaturated dicarboxylic acid having carbon number 5 or less such as maleic acid, itaconic acid are preferable.

As for other ethylenic unsaturated monomer, aromatic vinyl monomer, ethylenic unsaturated nitrile monomer, ethylenic unsaturated carboxylic acid amide monomer, etc. are exemplified.

As examples of the aromatic vinyl monomer, styrene, α-methylstyrene, vinyltoluene, chlorostyrene, hydroxylmethylstyrene, etc. are exemplified.

As examples of the ethylenic unsaturated nitrile monomer, acrylic nitrile, methacrylonitrile, fumaronitrile, α-chloroacrylic nitrile, α-cyanoethylacrylic nitrile, etc. are exemplified.

As examples of the ethylenic unsaturated carboxylic acid amide monomer, acrylamide, N-methylolacrylamide, N-methoxymethyl acrylamide, methacrylamide, N-methylolmethacrylamide, N-methoxymethylmethacrylamide, etc. are exemplified.

In these, the ethylenic unsaturated carboxylic acid ester monomer is preferable, particularly, ethyl acrylate, butyl acrylate, 2-ethylhexyl acrylate, ethyl methacrylate, butyl methacrylate, 2-ethylhexyl methacrylate are preferably used. By using such Co-monomer, flexibility is given to the polymer and a glass transition temperature (Tg) is decreased.

Content ratio of repeating unit derived from monomer represented by a formula (I) included in polymer to form the binder of the present invention is preferably 1 to 100 wt %, further preferably 2 to 75 wt % and particularly preferably 5 to 50 wt %. When the ratio of the repeating unit represented by the formula (I) is out of the above range, an active material containing polymer layer is sometimes removed from a collector at the time of winding electrode due to reducing flexibility, also, there will be possibility to decrease solubility to organic solvent or to deteriorate a rate property. The ratio of the compositional monomer derived from the monomer represented by the formula (I) included in the polymer can be controlled by a monomer feeding ratio represented by the formula (I) at the time of producing the polymer. Also, it is possible to analyze said ratio by “NMR”.

The glass transition temperature (Tg) of the polymer to form the binder of the present invention is preferably −50 to 50° C., more preferably −30 to 30° C., particularly preferably −20 to 20° C. When the “Tg” is excessively too low, there will be a risk of deterioration of the rate property, when the “Tg” is excessively too high, there is a possibility of reducing the binding force.

Also, a weight-average molecular weight of the polymer forming the binder of the present invention is 5000 to 2500000, preferably 10000 to 1000000, further preferably 20000 to 500000. When the weight-average molecular weight is too small, the binding force becomes weak and there will be a possibility to easily defect an active material of an obtainable electrode. On the other hand, when it is too large, a dispersion property of the active material is weaken, uniformity of the obtainable electrode is decreased. Note that, the weight-average molecular weight of the polymer is a weight-average molecular weight indicated as a weight-average molecular weight of polystyrene which is determined by gel permeation chromatography (GPC).

Also, the polymer to form the binder of the present invention may be dissolved in organic solvent. Here, the organic solvent means reaction solvent in case of using polymer liquid as is obtained by solution polymerization which will be described later, also, in case of using solvent displacement, it means displaced solvent.

The binder of the present invention has an action to reduce an interface resistance between the binder and the active material. As a result, the rate property can be improved due to lower an internal resistance of the electrode. Also, short circuit ratio is improved, because a dispersion property of the conductive material is improved, an improvement of a cycle property can be found as an overall effect. Although it is not clear as to why the polymer being the binder of the present invention has such functions and effects, it is presumed that such effects occur by coating a surface of the active material with said polymer. It is presumed, according to coating the surface of the active material with the polymer, hydrocarbon group having fluorine atom of side chain in the polymer accelerates desolvation of electrolyte ion such as Li ion and so on. Namely, insertion of Li ion to the surface of the active material is limited by solvate in normally, however, as a result of easily desorption of solvent, it is presumed that lowering resistance at the interface is provided.

Within a range of not inhibiting a purpose of the present invention, conventional binders such as PVDF, PTFE and rubbery polymer can be used in combination with the binder of the present invention.

A polymer to form the binder of the present invention can be obtained by performing solution polymerization the fluorine containing monomer represented by the above formula (I) and co-monomer used as desired under existence of polymerization initiator.

As for the polymerization initiator, commonly used component, for example, azo type polymerization initiator [for example, azobisnitrile (for example, 2,2′-azobisbutyronitriles such as 2,2′-azobisisobutyronitrile (AIBN); 2,2′azobisvaleronitriles such as 2,2′-azobis(2,4-dimethylvaleronitrile); 2,2′-azobispropionitriles such as 2,2-azobis (2-hydroxymethylpropionitrile); 1,1′-azobis-1-cycloalkanenitriles such as 1,1′-azobiscyclohexane-1-carbonitrile; azobiscyanocarboxylic acid such as 4,4′-azobis(4-cyanovaleric acid)), azonitrile (for example, azobutyronitriles such as 2-(carbamoylazo)isobutyronitrile; azovaleronitriles such as 2-phenylazo-4-methoxy-2,4-dimethylvaleronitrile)], peroxide polymerization initiator [for example, organic peroxides, ketone peroxides such as cyclohexanoneperoxide, 3,3,5-trimethylcyclohexanoneperoxide, methylcyclohexanoneperoxide, peroxy ketals such as 1,1-bis(t-butylperoxy)-3,3,5-trimethylcyclohexane, 1,1-bis(t-buthylperoxy)cyclohexane, n-butyl-4,4-bis(t-butylperoxy)pivalate, hydroperoxides such as cumenehydroperoxide, diisopropylbenzenehydroperoxide, 2,5-dimethylhexane-2,5-dihydroperoxide, dialkylperoxides such as di-t-butylperoxide, dicumylperoxide, t-butylcumylperoxide, α,α′-bis(t-butylperoxy-m-isopropyl)benzene, 2,5-dimethyl-2,5-di(t-butylperoxy)hexyne-3; diacylperoxides such as benzoylperoxide, decanoylperoxyde, lauroylperoxyde, 2,4-dichrolobenzoylperoxide; peroxy carbonates such as bis(t-butylcyclohexyl)peroxydicarbonate, peroxyesters such as t-butyl-peroxybenzoate, 2,5-dimethyl-2,5-di(benzoylperoxy)hexane; inorganic peroxides such as hydrogen peroxide, persulfate (potassium persulfate, ammonium persulfate)] are exemplified. Such polymerization initiator can be used with combination of one kind or two kinds or more.

Amount of use of the polymerization initiator is not particularly limited, for example, 0.1 to 10 parts by weight, preferably 1 to 5 parts by weight and so on to total 100 parts by weight of monomer.

As for polymerization temperature, normally, it may be selected from range of 50 to 120° C., preferably 60 to 90° C. or so. Note that, polymerization reaction may be run under an inert gas (for example, nitrogen gas, helium gas) atmosphere.

The organic solvent as a solvent when polymerization is not limited to one kind, and it may be a blended solvent by a plurality of kinds of organic solvent. Specifically, it is exemplified that aliphatic hydrocarbons such as pentane, hexane, heptane, etc., hydrocarbon system alcohols such as methanol, ethanol, n-propanol, isopropanol, tert-butyl alcohol, etc., hydrocarbon system ketones such as acetone, methyl ethyl ketone, methyl isobutyl ketone, cyclohexanone, etc., hydrocarbon system ethers such as dimethyl ether, diethyl ether, methylethyl ether, methyl tert-butyl ether, diethylene glycol dimethyl ether, tetraethylene glycol dimethyl ether, etc., cycloaliphatic hydrocarbon system ethers such as tetrahydrofuran, 1,4-dioxane, etc., nitriles such as acetonitrile, hydrocarbon system esters such as methyl acetate, ethyl acetate, propyl acetate, isopropyl acetate, butyl acetate, tert-butyl acetate, methyl propionate, ethyl propionate, etc., aromatic hydrocarbon systems such as toluene, xylene, etc., chlorohydrocarbon systems such as methylene chloride, chloroform, carbon tetrachloride, etc., fluorochlorohydrocarbon systems such as, 1,2,2-trichloro-1,2,2-trifluoroethane(R-113), 1,1,1-trichloro-2,2,2-trifluoroethane(R-113a), 1,1-dichloro-1-fluoroethane(R-141b), 3,3-dichloro-1,1,1,2,2-pentafluoropropane(R-225ca), 1,3-dichloro-1,1,2,2,3-pentafluoropropane(R-225cd), etc., fluorohydrocarbon systems such as 1,1,1,2,2,3,3,4,4,5,5,6,6-tridecafluorohexane, 1,1,1,2,2,3,3,4,4-nonafluorohexane, etc., fluorohydrocarbon system ethers such as methyl-2,2,3,3-tetrafluoroethylether, etc., fluorohydrocarbon system alcohols such as 2,2,2-trifluoroethanol, 1,1,1,3,3,3-hexafluoroisopropanol, 2,2,3,3-tetrafluoropropanol, 2,2,3,3,4,4,5,5-octafluoropentanol, etc., but are not limited to.

2. Binder Composition for Secondary Battery Electrode

A binder composition for secondary battery electrode of the present invention is formed by a polymer which forms the binder of the present invention is dissolved in organic solvent, the polymer content of said composition is preferably 0.2 to 70 wt %, further preferably 0.5 to 60 wt %, particularly preferably 0.5 to 50 wt %, most preferably 2 to 35%.

Organic solvent available to use for the binder composition of the present invention is exemplified that, aliphatic hydrocarbons such as n-octane, isooctane, nonane, decane, decalin, pinene, chlorododecane; cycloaliphatic hydrocarbons such as cyclopentane, cyclohexane, cycloheptane, methylcyclopentane; aromatic hydrocarbons such as toluene, styrene, chlorobenzene, chlorotoluene, ethylbenzene, diisopropylbenzene, cumene; alcohols such as methanol, ethanol, propanol, isopropanol, butanol, benzyl alcohol, glycerin; ketones such as acetone, methylethylketone, cyclopentanone, isophorone; ethers such as methylethylether, diethylether, tetrahydrofuran, dioxane; lactones such as γ-butyrolactone, δ-butyrolactone; lactams such as N-methylpyrrolidone, β-lactam; amides such as dimethylformamide, dimethylacetamide; compounds containing nitrile group such as methylenecyanohydrin, ethylenecyanohidrin, 3,3′-tiodipropionitrile, acetonitrile; nitrogen-containing heterocycle compounds such as pyridine, pyrrole; glycols such as ethyleneglycol, propyleneglycol; diethyleneglycols such as diethyleneglycol, diethyleneglycolmonoethylether, diethyleneglycolethylbutylether; esters such as ethyl formate, ethyl lactate, propyl lactate, methyl benzoate, methyl acetate, methyl acrylate. In addition, mixture of lacquer, gasoline, naphtha, kerosene can be used.

The binder composition of the present invention is formed by that the above mentioned polymer which forms the binder is dissolved in the above mentioned organic solvent. Polymer solution obtained by the above mentioned solution polymerization can be used as the binder composition as it, also it may be used to suitable solvent by solvent displacement.

Also, additives may be added to the binder composition of the present invention for improving coating property and charge-discharge property. As for the additives, cellulosic polymer such as carboxymethyl cellulose, methyl cellulose, hydroxypropyl cellulose, etc., polyacrylate such as sodium polyacrylate, polyvinyl alcohol, polyethylene oxide, polyvinyl pyrolidone, acrylic-vinyl alcohol copolymer, methacrylic-vinyl alcohol copolymer, maleic-vinyl alcohol copolymer, modified polyvinyl alcohol, polyethylene glycol, ethylene-vinyl alcohol copolymer, partially saponified polyvinyl acetate, etc. are exemplified. A ratio of the additives to the solid content of whole binder are preferably less than 300 wt %, more preferably 30 wt % or more to 250 wt % or less, particularly preferably 40 wt % or more to 200 wt % or less. When it is within this range, an electrode having excellent smoothness can be obtained.

These additives may be added following mentioned slurry for secondary battery electrode of the present invention, other than an adding method to the binder composition.

3. Slurry for Secondary Battery Electrode

The above mentioned binder composition becomes slurry for secondary battery electrode by mixing with electrode active materials and additives. The slurry for secondary battery electrode is used for producing electrode by coating a collector.

The electrode active material used for the present invention is compound which is available storing and discharging lithium ion. Electrode active materials for a positive electrode (positive electrode active material) are classified broadly into a material composed of inorganic compound and a material composed of organic compound. As for the positive electrode active material composed of inorganic compound, transition metal oxide, complex oxide of lithium and transition metal, transition metal sulfide, etc. are exemplified. As for the above mentioned transition metal, Fe, Co, Ni, Mn, etc. are used. As a specific example of the inorganic composition used for the positive electrode active material, transition metal oxide such as MnO, V₂O₅, V₆O₁₃, TiO₂, etc., complex oxide of lithium and transition metal such as lithium nickelate, lithium cobaltate, lithium manganate, etc. transition metal sulfide such as TiIS₂, FeS, MoS₂, etc. are exemplified. These compounds may be partially element substitution.

As for the positive electrode active material comprised an organic compound, for example, polyaniline, polypyrrole, polyacene, disulfide system compound, polysulfide system compound, N-fluoropyridinium salt, etc. are exemplified. The positive electrode active material may be mixture of the above mentioned inorganic compound and organic compound. Although a particle size of the positive electrode active material used of the present invention is suitably selected by balance of other configuration requirements of a battery, 50% accumulated volume diameter is normally 0.1 to 50 μm, preferably 1 to 20 μm, in view of improving battery property such as a load characteristic, a cycle property, etc. When the 50% accumulated volume diameter is within this range, a secondary battery having large discharge-charge capacity can be obtained, and ease of handling when producing the slurry for electrode and the electrode. The 50% accumulated volume diameter can be determined by measuring particle size distribution by laser diffraction.

As for an electrode active material for a negative electrode (negative electrode active material), carbon allotrope such as graphite and coke, etc. are exemplified. An electrode active material comprised said carbon allotrope may be used as configurations of mixture or enclosure with metal, metallic salt, oxide, etc. Also, as for the negative electrode active material, oxides and sulfates such as silicon, tin, zinc, manganese, iron, nickel, etc., lithium alloy such as metallic lithium, Li—Al, Li—Bi—Cd, Li—Sn—Cd, etc., lithium transition metal nitride, silicon, etc., may be used. Although a particle size of the negative electrode active material is suitably selected by balance of other configuration requirement of a battery, 50% accumulated volume diameter is normally 1 to 50 μm, preferably 15 to 30 μm, in view of improving battery property such as an initial efficiency, a load characteristic, a cycle property, etc.

A ratio of amount of the active material and the above mentioned binder is that the binder is normally 0.1 to 30 parts by weight, preferably 0.2 to 20 parts by weight, more preferably 0.5 to 10 parts by weight to 100 parts by weight of the electrode active material. When the amount of binder is within this rage, the obtainable electrode is excellent binding forces with the collector and an active material layer, and the active material layer inside, and a battery having small internal resistance and excellent cycle property can be obtained.

The slurry for secondary battery electrode of the present invention may be comprise additives to realize various of functions such as viscosity improver, conductive material, reinforcing material, other than the electrode active material and the above mentioned binder, if necessary. As for the viscosity improver, a polymer dissolvable to organic solvent used for slurry for electrode is used. Specifically, acrylonitrile-butadiene copolymer hydride is used. As for the conductive material, although it is not particularly limited if conductive property can be provided, in normally, carbon powder such as acetylene black, carbon black, graphite, etc., fiber and foil of various metals are exemplified. As for the reinforcing material, spherical shape, plate shape, rod shape or fibrous inorganic and organic fillers of various kinds can be used.

Further, trifluoropropylene carbonate, vinylene carbonate, catechol carbonate, 1,6-dioxasupiro[4,4]nonane-2, 7-dion, 12-crown-4-ether, etc., can be use for the slurry for secondary battery electrode of the present invention for improving stability and durability of battery. Also, these may be used with containing following mentioned electrolysis solution.

Amount of the organic solvent at the slurry for secondary battery electrode is used by adjusting so that being preferable viscosity for coating, in response to kinds of the electrode active material or the binder. Specifically, concentration of solid content of the electrode active material, the binder and other additives in total amount is used so as to be adjusted as being preferably 30 to 90 wt %, further preferably 40 to 80 wt %.

The slurry for electrode can be obtained by a blending machine to blend the binder composition for secondary battery electrode, the electrode active material, additives added in response to necessity and other organic solvent. Although the blending may be performed by supplying the above respective components at once, dispersing conductive material as particulate by blending the conductive material and the viscosity improver in the organic solvent, then adding the binder composition for secondary battery electrode and the electrode active material for further mixing is preferable because dispersion property of the slurry is improved. As for the blending machine, although a ball mill, sand mill, pigment disperser, mincing crushing machine, supersonic disperser, homogenizer, planetary mixer, hobart mixer, etc., the ball mill is preferable because aggregation of the conductive material and the electrode active material can be prevented.

A granularity of the slurry for secondary battery electrode is preferably 35 μm or less, further preferably 25 μm or less. When the granularity of the slurry is within the above range, a homogenous electrode can be obtained so that the conductive material has high dispersibility.

4. Secondary Battery Electrode

A secondary battery electrode of the present invention is that the slurry for the secondary battery electrode is adhered to a collector such as metal foil, etc. As a manufacturing method for the subject secondary battery electrode, for example, a method of coating the above slurry to the collector and drying can be exemplified. The electrode active material is fixed into the binder formed on a surface of the collector with dispersion status.

Although the collector is not particularly limited if including conducting property, normally, metal foil such as aluminum foil, copper foil, etc. Although a thickness of the metal foil is not particularly limited, in normally 1 to 50 μm, preferably 1 to 30 μm. When the thickness of the collector is too thin, there is sometime a productive problem such as tends to breakage, wrinkling due to mechanical strength is weaken, when too thick, it tends to a capacity decreasing as a whole battery. The surface of the collector is preferable to be roughened in view of improving binding force with the active material layer. As for the roughening surface method, mechanical polishing, electropolishing, chemical polishing, etc. are exemplified. In the mechanical polishing, a coated abrasive to which abrasive particle is fixed, grinding stone, emery wheel, wire brush having steel wire, etc. is used. Also, an intermediate layer may be formed on a surface of the collector for improving binding strength and conductive property with the active material layer.

Coating method of the slurry to the collector is not particularly limited. For example, doctor blade method, dip method, reverse roll method, direct roll method, gravure method, extrusion method, brush coating, etc. are used for coating. Although an amount of coating is not particularly limited, the amount is a thickness of the active material layer formed after removing the organic solvent is normally 0.005 to 5 mm, preferably 0.01 to 2 mm and the like. The drying method is not particularly limited, for example, drying by warm air, hot air, low humid air, drying in a vacuum, drying by irradiating (far) infrared ray and electron beam, etc. are exemplified. The drying condition is normally adjusted so that the liquid medium is vaporized as soon as possible within a speed range wherein the active material layer does not crack due to the concentration of the stress, or the active material layer is not removed from the collector or so.

Further, the electrode may be stabilized by pressing the collector after drying. As for the pressing method, die pressing and calendared pressing method, etc., are exemplified.

The binder of the present invention has an action to reduce an interface resistance between the binder and the active material. As a result, the rate property can be improved due to lower an internal resistance of the electrode. Also, a short circuit ratio is improved, because a dispersion property of the conductive material is improved, an improvement of a cycle property can be found as an overall effect. Although it is not clear as to why the polymer being the binder of the present invention has such functions and effects, it is presumed that such effects occur by coating a surface of the active material with said polymer. It is presumed, according to coating the surface of the active material with the polymer, hydrocarbon group having fluorine atom of side chain in the polymer accelerates desolvation of electrolyte ion such as Li ion and so on. Namely, insertion of Li ion to the surface of the active material is limited by solvate in normally, however, as a result of easily desorption of solvent, it is presumed that lowering resistance at the interface is provided.

5. Secondary Battery

A secondary battery of the present invention comprise the above mentioned secondary battery electrode of the present invention. Precisely, it can be obtained by combining the above mentioned secondary battery electrode and electrolyte solution, conventionally known separator and components such as battery casing, etc. As for the specific manufacturing method, for example, a method of overlapping a positive electrode and a negative electrode via the separator, and winding or folding thereof in response to a shape of the battery to insert into a battery casing, then electrolyte solution is filled into the battery casing and sealing is exemplified. Also, if necessary, rising internal pressure force of battery, over discharge and charge may be prevented by inserting over-current protection element such as expand metal, fuse, PTC element, lead plate, etc. As for the battery shape, it may be any shapes such as coin shape, button shape, sheet shape, cylindrical shape, square shape, flat shape.

As for the electrolyte solution, an organic electrolyte solution wherein supporting electrolyte is dissolved into the organic solvent is used. As for the supporting electrolyte, lithium salt is used. As for the lithium salt, although it is not particularly limited, LiPF₆, LiAsF₆, LiBF₄, LiSbF₆, LiAlCl₄, LiClO₄, CF₃SO₃L₁, C₄F₉SO₃Li, CF₃COOLi, (CF₃CO)₂NLi, (CF₃SO₂)₂NLi, (C₂F₅SO₂)NLi, etc. are exemplified. In these, it is preferable LiPF₆, LiClO₄, CF₃SO₃Li which are easily dissolved with solvent and shows high degree of dissociation. They may be co-used more than two kinds. While using supporting electrolyte having high dissociation degree, lithium ion conductivity becomes hither, thus, the lithium ion conductivity can be adjusted according to a kind of the supporting electrolyte.

As for the organic solvent used for electrolyte solution, although it is not particularly limited if the supporting electrolyte can be dissolved, carbonates such as dimethyl carbonate (DMC), ethylene carbonate (EC), diethyl carbonate (DC), propylene carbonate (PC), butylene carbonate (BC), methylethyl carbonate (MEC); ethers such as γ-butyrolactone, methyl formate; esters such as 1,2-dimethoxyethane, tetrahydrofuran; sulfur containing compounds such as sulfolane, dimethyl sulfoxide; are preferably used. Also, these solvent mixture liquids may be used. In these, carbonates are preferable because having high permittivity, wide and stable electric potential. While viscosity of solvent used is lower, the lithium ion conductivity becomes higher, the lithium ion conductivity can be adjusted by a kind of solvent.

Concentration of the supporting electrolyte in the electrolyte is normally 1 to 30 wt %, preferably 5 to 20 wt %. Also, in response to kinds of the supporting electrolyte, in normally, it is used as concentration of 0.5 to 2.5 mol/l. The ionic electric conductivity tends to decrease either when the concentration of the supporting electrolyte is too low and too high. When concentration of the used electrolyte is too low, degree of swelling of polymer particle becomes larger, the lithium ion conductivity can be adjusted by the concentration of the electrolyte.

### EXAMPLES

Below, the present invention will be specified with examples, however, the present invention is not limited thereto. Note that, in the examples, parts and percentages are by weight unless otherwise indicated.

Evaluations in the examples and comparative examples are performed in following conditions.

(1) Producing Battery

2 parts of the polymer solution (in a comparative example 5, polymer dispersion) prepared in examples and comparative examples in polymer solids conversion, 100 parts of LiCoO₂ powder having 10 μm average particle size as a positive electrode active material and 2 parts of acetylene black as conductive material, adding 30 parts of NMP (N-methylpyrrolidone) as solvent are blended by a planetary mixer to obtain the slurry for electrode. Then, the slurry electrode is equality coated to an aluminum foil having 20 μm thickness by doctor blade method, drying 15 min by a drying machine at 120° C. Next, pressing by a two axis roll press and further drying under reduced pressure by a vacuum dryer under 0.6 kPa during 10 hrs at 250° C. to obtain the positive electrode wherein a thickness of the active material layer is 110 μm.

Next, the obtained electrode is cutout as a circular sheet of 15 mm diameter. A separator comprised a circular polypropylene porous film having 18 mm diameter and 25 μm thickness, a metal lithium used as a negative electrode and an expand metal are laminated sequentially on an active material layer side of the positive electrode, and enclosed into a coin shaped outer container made of stainless steel wherein a polypropylene packing is equipped (20 mm diameter, 1.8 mm height, 0.25 mm stainless steel thickness). The electrolyte is filled in to the container so that the air is not lefted, and the stainless steel cap having a thickness of 0.2 mm is fixed by covering the outer container via the polypropylene packing, then the battery can is sealed, thereby the coin shaped battery having a diameter at 20 mm, a thickness of about 2 mm is produced.

(2) Charge-Discharge Cycle Properties

Charge-discharge cycle is performed by using the obtainable coin shape battery under charging to 4.3V with 0.1 C constant current at 20° C. and discharging to 3.0V with 0.1 C constant current, respectively. The charge-discharge cycle is preformed up to 100 cycles, then, a ratio of discharge capacity at 100th cycle to an initial discharge capacity is defined as a capacity maintenance ratio, and determining by following criteria. When this value is larger, it is shown that a capacity decreasing by repeating charge and discharge is small.

A: 80% or more
B: 75% or more, less than 80%
C: 70% or more, less than 75%
D: 60% or more, less than 70%
E: less than 60%

(3) Charge-Discharge Rate Properties (Load Characteristic)

Other than changing the constant current as 2.0 C, the discharge capacities at the respective constant current are measured as similar with measuring the charge-discharge cycle property. A ratio of discharge capacity at 2.0 C to a battery capacity at 0.1 C is calculated by percentage and defining as charge-discharge properties, and determining by following criteria. When this value is larger, it is shown that an internal resistance is small and high speed charge-discharge is available.

A: 60% or more
B: 55% or more, less than 60%
C: 50% or more, less than 55%
D: less than 50%

(4) Short Circuit Ratio

After producing the coin shape battery, an electric potential less than 3V is regarded as short circuit, determining number of short circuit battery with following criteria. Note that, numbers of sample are 10 samples.

### A: 0

### B: 1

### C: 2

D: 3 or more

(5) Granularity of Slurry for Electrode

A granularity of the slurry for electrode is determined by a gauge (particle gauge) conformed to JIS K5600-2-5:1999 as follows. Occurrence points of stripes observed on the gauge, 3rd largest value is read. Performing measuring at 6 times, the measured average values are defined as granularity and determining with following criteria. As the granularity is smaller, it is shown that dispersibility of the conductive material and the active material are excellent.

A: less than 25μ
B: 25μ or more, less than 35μ
C: 35μ or more, less than 50μ
D: 50μ or more

(6) Flexibility

An electrode is cut up in a dimension with 3 cm width×9 cm length for a test specimen. Put the test specimen on a desk with a status that a collector side face of the test specimen faces to the desk, a stainless bar having 1 mm diameter is laid on the face of the collector side at a short side direction in a position of a center of a longitudinal direction (at a position of 4.5 cm from a tip end portion). The test specimen is folded at 180° so that the active material layer becomes outside together with the stainless bar is a center. Conducting test for 10 sheets of the test specimens, presence or absence of cracking or peeling with respect to the folded portion of the active material layer of the respective test specimen are observed, and determining by following criteria. Lesser cracking and peeling show excellent flexibility of the electrode.

A: Cracking and peeling cannot be found in whole 10 sheets
B: Cracking and peeling are found in 1 to 3 sheets of 10 sheets
C: Cracking and peeling are found in 4 to 9 sheets of 10 sheets
D: Cracking and peeling are found in whole 10 sheets

(7) Binding Properties

An electrode is cut up in a dimension with 2.5 cm width×10 cm length for a test specimen and to fix the specimen as facing up active material layer. After adhering adhesive cellophane tape to the surface of the active material layer of the specimen, stress is measured when removing the adhesive cellophane tape from one end of the specimen to 180° direction at a speed of 50 mm/min. Measuring 10 times and an average value is determined which defined as a peeling strength, and determining by following criteria. Larger the peeling strength shows large binding force of the active material layer to the collector.

A: 0.65N/cm or more
B: 0.50N/cm or more, less than 0.65N/cm
C: 0.40N/cm or more, less than 0.50N/cm
D: 0.20N/cm or more, less than 0.40N/cm
E: less than 0.20N/cm

### Example 1

Put 200 parts of toluene, 0.1 parts of 2,2′-azobisisobutyronitrile as a polymerization initiator, 40 parts of 2-(perfluorotetradodecyl)ethyl acrylate, 60 parts of 2-ethylhexyl acrylate into a glass reactor, after operating nitrogen substitution sufficiently, initiating polymerization by heating to 80° C. Then, finish the reaction after 5 hours by cooling to obtain toluene solution of the polymer. A weight-average molecular weight of said polymer is 120000.

Blending said polymer solution and 3 times weight of N-methylpyrrolidone, vaporizing the toluene by an evaporator to obtain N-methylpyrrolidone solution of the polymer. The slurry for electrode and the battery are produced by using this polymer solution with the above mentioned method. Evaluation result is shown in Table 1.

### Example 2

Other than using 10 parts of 2-(perfluorooctyl)ethyl acrylate instead of the 2-(perfluorotetradodecyl)ethyl acrylate, 90 parts of butyl acrylate instead of 2-ethylhexyl acrylate, operating polymerization under similar condition with the example 1, and toluene solution of the polymer is obtained. Note that a weight-average molecular weight of the polymer is 200000. A test similar with the example 1 is performed by using said polymer solution. A result is shown in Table 1.

### Example 3

Other than using 10 parts of 2-(perfluorohexyl)ethyl acrylate instead of the 2-(perfluorotetradodecyl)ethyl acrylate, and using 90 parts of 2-ethylhexyl acrylate instead of 60 parts of 2-ethylhexyl acrylate, operating polymerization under similar condition with the example 1, and toluene solution of the polymer is obtained. Note that a weight-average molecular weight of the polymer is 200000. A test similar with the example 1 is performed by using said polymer solution. A result is shown in Table 1.

### Example 4

Other than using 10 parts of 2-(perfluorohexadecyl)ethyl acrylate instead of the 2-(perfluorotetradodecyl)ethyl acrylate, and using 90 parts of 2-ethylhexyl acrylate instead of 60 parts of 2-ethylhexyl acrylate, operating polymerization under similar condition with the example 1, and toluene solution of the polymer is obtained. Note that a weight-average molecular weight of the polymer is 100000. A test similar with the example 1 is performed by using said polymer solution. A result is shown in Table 1.

### Example 5

Other than using 10 parts of 2-(perfluorooctyl)ethyl acrylate instead of the 2-(perfluorotetradodecyl)ethyl acrylate, and using 80 parts of 2-ethylhexyl acrylate and 10 parts of acrylonitrile instead of 60 parts of 2-ethylhexyl acrylate, operating polymerization under similar condition with the example 1, and toluene solution of the polymer is obtained. Note that a weight-average molecular weight of the polymer is 180000. A test similar with the example 1 is performed by using said polymer solution. A result is shown in Table 1.

### Example 6

Other than using 10 parts of 2-(perfluorooctyl)ethyl acrylate instead of the 2-(perfluorotetradodecyl)ethyl acrylate, and using 87 parts of 2-ethylhexyl acrylate and 3 parts of glycidyl methacrylate instead of 60 parts of 2-ethylhexyl acrylate, operating polymerization under similar condition with the example 1, and toluene solution of the polymer is obtained. A test similar with the example 1 is performed by using said polymer solution. A result is shown in Table 1.

### Example 7

Other than using 60 parts of 2-(perfluorohexyl)ethyl acrylate instead of the 2-(perfluorotetradodecyl)ethyl acrylate, and using 40 parts of butyl acrylate instead of 60 parts of 2-ethylhexyl acrylate, operating polymerization under similar condition with the example 1, and toluene solution of the polymer is obtained. A test similar with the example 1 is performed by using said polymerization solution. A result is shown in Table 1.

### Example 8

Other than using 3 parts of 2-(perfluorohexadecyl)ethyl acrylate instead of the 2-(perfluorotetradodecyl)ethyl acrylate, and using 97 parts of butyl acrylate instead of 60 parts of 2-ethylhexyl acrylate, operating polymerization under similar condition with the example 1, and toluene solution of the polymer is obtained. A test similar with the example 1 is performed by using said polymer solution. A result is shown in Table 1.

### Example 9

2 parts of the polymer solution prepared in Example 2 by polymer solid conversion, 100 parts by mass of artificial graphite having an average particle size 24.5 μm as a negative electrode active material are inserted into a planetary mixer and mixing to obtain the slurry for electrode. The slurry electrode is equality coated to a copper foil having 18 μm thickness by doctor blade method, heating 20 min at 110° C. after drying 20 min by a drying machine at 50° C. Next, pressing by a two axis roll press and further drying under reduced pressure by a vacuum dryer under 0.6 kPa during 10 hrs at 250° C. to obtain the negative electrode wherein a thickness of the active material layer is 100 μm.

Next, this electrode is cutout as a circular sheet of 15 mm diameter. A separator comprised a circular polypropylene porous film having 18 mm diameter and 25 μm thickness, a metal lithium used as a positive electrode and an expand metal are laminated sequentially on an active material layer side of the negative electrode, and enclosed into a coin shaped outer container made of stainless steel wherein a polypropylene packing is equipped (20 mm diameter, 1.8 mm height, 0.25 mm stainless steel thickness). The electrolyte is filled in to the container so that the air is not lefted, and the stainless steel cap having a thickness of 0.2 mm is fixed by covering the outer container via the polypropylene packing, then the battery can is sealed, thereby the coin shaped battery having a diameter at 20 mm, a thickness of about 2 mm is produced. A test similar with the example 1 is performed with respect to the obtainable slurry for electrode and the coin shape battery. A result is shown in Table 1.

### Comparative Example 1

Other than not using 2-(perfluorotetradodecyl)ethyl acrylate, and only using 100 parts of 2-ethylhexyl aclyate, operating polymerization under similar condition with the example 1, and toluene solution of the polymer is obtained. Note that a weight-average molecular weight of the polymer is 170000. A test similar with the example 1 is performed by using said polymerization solution. A result is shown in Table 1.

### Comparative Example 2

Other than using 30 parts of 2-(perfluoroethyl)ethyl acrylate instead of 2-(perfluorotetradodecyl)ethyl acrylate, using 70 parts of butyl acrylate instead of 2-ethylhexyl acrylate, operating polymerization under similar condition with the example 1 to obtain toluene solution of the polymer. Note that a weight-average molecular weight of the polymer is 180000. A test similar with the example 1 is performed by using said polymer solution. A result is shown in Table 1.

### Comparative Example 3

Other than using 20 parts of 2-(perfluorooctadecyl)ethyl acrylate instead of 2-(perfluorotetradodecyl)ethyl acrylate, and using 80 parts of butyl acrylate instead of 2-ethylhexyl acrylate, operating polymerization under similar condition with the example 1 to obtain toluene solution of the polymer. Note that a weight-average molecular weight of the polymer is 90000. A test similar with the example 1 is performed by using said polymer solution. A result is shown in Table 1.

### Comparative Example 4

Other than using 10 parts of 2-(perfluoroethyl)ethyl acrylate instead of 2-(perfluorotetradodecyl)ethyl acrylate, and using 90 parts of butyl acrylate instead of 2-ethylhexyl acrylate, operating polymerization under similar condition with the example 1 to obtain toluene solution of the polymer. Note that a weight-average molecular weight of the polymer is 150000. A test similar with the example 1 is performed by using said polymer solution. A result is shown in Table 1.

### Comparative Example 5

1000 parts of ion exchanged water, 10 parts of 2-(perfluorooctyl)ethyl acrylate and 90 parts of 2-ethylhexyl acrylate as a monomer, 5 parts of cumenehydroperoxide as a cross-linking agent, 5 parts of sodium dodecylbenzenesulfonate as an emulsifier, and 5 parts of potassium persulfate as a polymerization initiator are input into a reaction vessel equipped with a stirrer, polymerizing by heating to 80° C., after sufficiently stirring. When a consumption of the monomer becomes 99.0%, the reaction is stopped by cooling, aqueous dispersion of particular state 2-(perfluorooctyl)ethyl acrylate/2-ethylhexyl arylate copolymer is obtained. Note that, the obtainable copolymer is a form of gel, and a weight-average molecular weight is immeasurable. Said aqueous dispersion and 3 times weight of N-methylpyrrolidone are mixed and water is evaporated by an evaporator, 10% N-methylpyrrolidone dispersion of polymer is obtained. The slurry for electrode and the battery are produced by the above mentioned method. Evaluation result is shown in Table 1.

### Comparative Example 6

Other than using polymer solution prepared in the comparative example 1, the slurry for electrode and the coin shape battery are produced as similar with the example 9. A test similar with the example 1 is performed with respect to the slurry for electrode and the coin shape battery which are obtainable herein. A result is shown in Table 1.

TABLE 1

| | Granularity | | | | | |
|---|---|---|---|---|---|---|
| | of Slurry for | Charge-Discharge | Charge-Discharge | Short Circuit | | Binding |
| | Electrode | Cycle Property | Rate Property | Ratio | Flexibility | Property |
| Example 1 | A | A | B | A | B | C |
| Example 2 | A | A | A | A | A | B |
| Example 3 | A | A | B | A | B | B |
| Example 4 | A | A | B | A | B | B |
| Example 5 | A | A | A | A | B | B |
| Example 6 | A | A | A | A | A | A |
| Example 7 | B | B | B | B | A | B |
| Example 8 | C | B | B | B | A | B |
| Example 9 | A | A | A | A | A | B |
| Comparative Example 1 | D | E | D | C | A | A |
| Comparative Example 2 | C | C | C | B | A | B |
| Comparative Example 3 | B | C | C | A | B | D |
| Comparative Example 4 | C | D | C | B | A | A |
| Comparative Example 5 | D | E | D | B | B | A |
| Comparative Example 6 | D | E | D | C | A | B |

From Table 1, when using a binder composed of polymer having defined amount of a monomer unit derived from fluorine atom containing monomer defined in the present invention and a weight-average molecular weight is within a defined range, improvement of a rate property, cycle property and short circuit ratio of electrode is shown. Contrary this, when using a polymer not including fluorine atom containing monomer defined in the present invention (comparative examples 1 to 4, 6) and using a gel form polymer to which a weight-average molecular weight was immeasurable (comparative example 5), the above various properties are not improved.

1. A binder for secondary battery electrode comprising a polymer having weight-average molecular weight of 5000 to 2500000 formed by polymerizing a monomer composition including fluorine atom containing monomer represented by following formula (I). 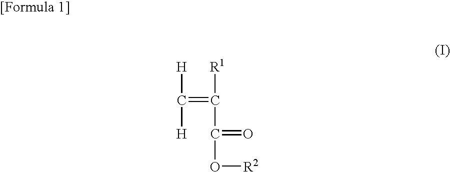
(R¹ is hydrogen or methyl group, R² is hydrocarbon group having carbon number 6 to 18 containing fluorine atom).

2. The binder for secondary battery electrode as set forth in claim 1, wherein a ratio of repeating unit derived from monomer represented by said formula (I) included in said polymer is 1 to 100 wt %.

3. The binder for secondary battery electrode as set forth in claim 1 or 2, wherein said monomer composition further comprises ethylenic unsaturated carboxylic acid ester monomer.

4. A binder composition comprising an organic solvent and dissolved therein the binder for secondary battery electrode as set forth in claim 1.

5. A slurry for secondary battery electrode comprising the binder composition as set forth in claim 4, and a positive electrode active material or a negative electrode active material.

6. A secondary battery electrode, wherein an active material layer comprising the binder for secondary battery electrode as set forth in claim 1, and a positive electrode active material or a negative electrode active material is adhered to a collector.

7. A secondary battery comprising the secondary battery electrode as set forth in claim 6.
